(19) United States
(12) Patent Application Publication
(10) Pub. No.: US 2007/0278750 A1
(43) Pub. Date: Dec. 6, 2007

(54) Fuel Injection Valve

(76) Inventors: Shinji Okuhara, Higashimatsuyama-shi (JP); Toru Horie, Higashimatsuyama-shi (JP); Kiyoshi Matsuzaki, Higashimatsuyama-shi (JP); Kenichi Neki, Higashimatsuyama-shi (JP); Kazuo Koshizuka, Higashimatsuyama-shi (JP)

Correspondence Address: CONNOLLY BOVE LODGE & HUTZ LLP, 1875 EYE STREET, N.W., SUITE 1100, WASHINGTON, DC, 20036, US

(21) Appl. No.: 10/586,058

(22) PCT Filed: Jan. 14, 2005
(86) PCT No.: PCT/JP05/00716

§ 371 Date: Apr. 25, 2007

(30) Foreign Application Priority Data
Jan. 22, 2004 (JP) 2004-14138

(51) Int. Cl. F02F 11/00

(52) U.S. Cl. 277/592; 239/602

(57) ABSTRACT

In a fuel injection valve (1) having a nozzle body (31) with a nozzle hole (35) at its tip that is opened and closed by a nozzle needle (32) housed in the nozzle body (31), the area of contact between the nozzle needle (32) and a seat (31A) on the nozzle body (31) is provided with a coating layer (Y) to reduce the frictional resistance with the nozzle body (31). When the nozzle needle (32) seats on the seat (31A), between the time from when the tip of the nozzle needle (32) contacts the seat (31A) to when it is pressed against the seat (31A), the nozzle needle (32) slides on the surface of the nozzle body (31) with low frictional resistance. As a result, wear on the seat (31A) when the nozzle needle (32) is seated to open the valve can be kept down.

### TECHNICAL FIELD

The present invention relates to a fuel injection valve for injecting fuel into the cylinders of an internal combustion engine.

### BACKGROUND ART

As a fuel injection valve for injecting fuel into an internal combustion engine, there is publicly known a type of fuel injection valve disclosed in, for example, Japanese Unexamined Patent Application Publication No. Hei 7-310621. This fuel injection valve is for directly injecting fuel into the cylinders of an internal combustion engine, and comprises a control chamber in the body of the injection valve that is connected to a fuel low-pressure section by energizing an electromagnetic actuator, which, by removing the valve piston back pressure, raises the nozzle needle to thereby start fuel injection. After a prescribed time has elapsed, the energizing of the electromagnetic actuator is stopped, breaking the connection state between the control chamber and the fuel low-pressure section, whereby a prescribed back pressure acts on the valve piston, pushing down the nozzle needle and thereby terminating the fuel injection.

In this way, initiation and termination of fuel injection are carried out by controlling the back pressure of the valve piston to use the nozzle needle to close and open the nozzle hole in the nozzle body. Thus, there is a problem of the repeated impact of the nozzle needle on the nozzle body causing wear on the nozzle needle and the nozzle body which, over time, changes the fuel injection characteristics of the fuel injection valve.

To resolve this problem, in the prior art, a material that has a high hardness is selected as the material of the nozzle needle to reduce nozzle needle wear and deformation and obtain stable fuel injection characteristics over an extended period of time.

However, even if wear on the nozzle needle is reduced by increasing the hardness of the nozzle needle, the initial hardness cannot be maintained since the hardness of the nozzle body is reduced by heat, so wear of the nozzle body arises due to the nozzle needle impacting against the nozzle body during valve close operations. As a result, the wear on the nozzle body increases with the passing of time, gradually changing the nozzle needle seating position, altering the fuel injection characteristics, thereby making it impossible to obtain stable fuel injection characteristics over an extended period of time.

An object of the present invention is to provide a fuel injection valve that overcomes the above problems of the prior art.

An object of the present invention is to provide a fuel injection valve that can effectively suppress wear of the seat portion of the nozzle body caused by the nozzle needle seating on the nozzle body.

### DISCLOSURE OF THE INVENTION

To resolve the above problems, focusing on the frictional resistance between the nozzle needle and the nozzle body seat when the nozzle needle seats on the nozzle body seat portion, the present invention effectively suppresses wear on the seat portion by keeping down that frictional resistance.

In accordance with the present invention, in a fuel injection valve having a nozzle body with a nozzle hole(s) at its tip that is opened and closed by a nozzle needle housed in the nozzle body, a fuel injection valve is provided that is characterized in that an area of contact between the nozzle needle and a seat on the nozzle body is provided with a coating layer to reduce the frictional resistance with the nozzle body.

The coating layer may be provided by applying a C2 coat to the tip of the nozzle needle, or by providing a DLC thin film. By thus providing a coating layer, when the nozzle needle seats on the seat portion in the nozzle body, during the period from when the nozzle needle contacts the seat portion to when it presses against the seat portion, the nozzle needle slides on the surface of the nozzle body with a small frictional resistance. As a result, it is possible to keep down wear of the seat portion when the nozzle needle is seated to open the valve.

### BRIEF DESCRIPTION OF THE DRAWINGS

FIG. 1 is a sectional view of an embodiment of this invention.

FIG. 2 is an enlarged view showing details of the nozzle portion of FIG. 1.

FIG. 3 is an enlarged sectional view of an essential portion of FIG. 2.

FIG. 4 is a graph showing the measured wear ratio in the case of the embodiment, together with the measured wear ratio in the case of a fuel injection valve of the prior art.

### BEST MODE OF CARRYING OUT THE INVENTION

The invention will now be described in further detail, with reference to the appended drawings.

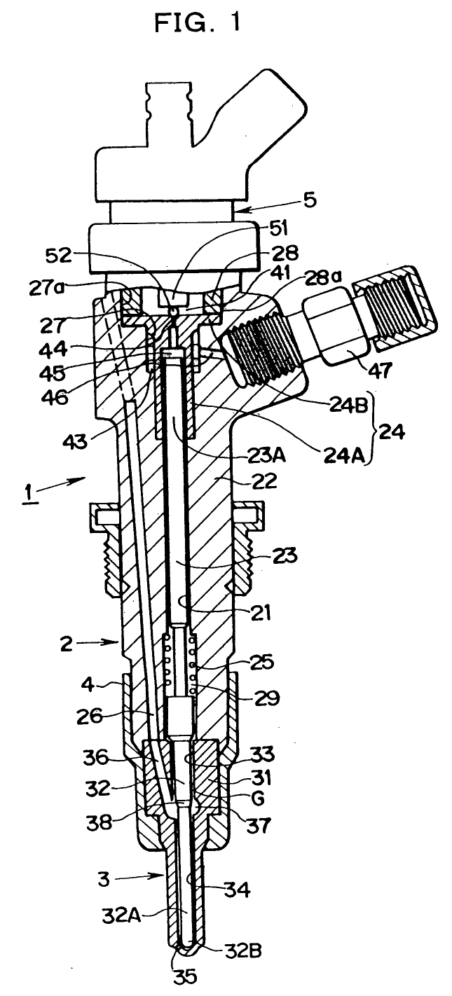

FIG. 1 shows a sectional view of an embodiment of the fuel injection valve according to this invention. Reference symbol 1 denotes a fuel injection valve used in a common rail system for the injected supply of fuel in a diesel internal combustion engine. The fuel injection valve 1 is attached to the cylinder of a diesel internal combustion engine (not shown) to directly inject into the cylinder at a prescribed timing a prescribed amount of high-pressure fuel supplied from a common rail that is not shown. A nozzle 3 is affixed to the tip of a nozzle holder 2 by a retaining nut 4. An electromagnetic actuator 5 is provided at the rear end of the nozzle holder 2.

The nozzle holder 2 has an injector housing 22 with a guide hole 21 formed in the axial direction thereof; inside the guide hole 21 is a valve piston 23 that can move axially by means of the guide hole 21. A spring 25 is housed in a spring chamber 29 of the injector housing 22; the spring 25 urges a nozzle needle 32, described later, in the direction of a nozzle hole 35. Reference symbol 26 denotes a passage provided in the injector housing 22 for feeding high-pressure fuel from the common rail (not shown) to the nozzle 3. The nozzle 3 has a nozzle body 31 and the nozzle needle 32, with the nozzle needle 32 being housed in the nozzle body 31 to be axially movably supported and guided thereby by means of a hole 33 formed coaxially in the nozzle body 31. A tip portion 32A of the nozzle needle 32 extends within a cylinder portion 34 provided in the nozzle body 31 in alignment with the hole 33, forming a configuration in which the tip of the nozzle needle 32 functions as a valve element that opens and closes the nozzle hole 35.

Thus, when the nozzle needle 32 is held in a position in which it closes the nozzle hole 35, fuel is not sprayed from the fuel injection valve 1. On the other hand, when the nozzle needle 32 is retracted, opening the nozzle hole 35, and the nozzle needle 32 is maintained in that position, fuel sprays from the fuel injection valve 1.

Formed in the nozzle body 31 is a fuel reservoir 37 in which high-pressure fuel from the passage 26, guided via a passage 36, collects. On the other hand, a tapered portion 38 is formed on the nozzle needle 32 to enable the pressure of the high-pressure fuel in the fuel reservoir 37 to act as a force that pushes the nozzle needle 32 away from the nozzle hole 35.

Housed at the rear end of the injector housing 22 is a valve body 24 comprising a drive mechanism for driving the nozzle 3 in association with the valve piston 23. The valve body 24 is integrally formed by a lower cylindrical portion 24A and an upper flange portion 24B, and is contained in a hole portion 27 for housing the valve body 24 provided at the rear end of the injector housing 22.

The hole portion 27 is formed in a shape that approximately corresponds to the outside shape of the valve body 24; the bottom of the hole portion 27 connects to the guide hole 21 into which the valve piston 23 is inserted until the upper end 23A of the valve piston 23 is in the lower cylindrical portion 24A. There is an oil-tight state between the outside surface of the valve piston 23 and the inside surface of the lower cylindrical portion 24A.

A nut 28 is screwed into the opening portion of the hole portion 27 to fix the valve body 24 at the prescribed position in the hole portion 27. A thread 28a formed on the outside surface of the nut 28 engages with a thread 27a on the inside surface of the opening portion of the hole portion 27, and the valve body 24 is affixed to the injector housing 22 by tightening the nut 28 towards the valve body 24.

As described above, the valve piston 23 and valve body 24 are assembled into the injector housing 22. At the rear end of the injector housing 22, there are formed a drain chamber 41, a radial supply passage 43 and an axial drain passage 44 that communicates with a control chamber 45. The supply passage 43 communicates with an intake fitting 47 via a radial guide passage 46 inside the injector housing 22; the bottom of the control chamber 45 is formed by the top surface of the valve piston 23.

Affixed to the armature bolt 51 of the electromagnetic actuator 5 is a ball 52 functioning as a valve element that constitutes a valve mechanism controlling the state of communication between the control chamber 45 and the fuel low-pressure section. The armature bolt 51 is urged towards the drain passage 44 by the force of a valve spring (not shown), whereby the drain passage 44 is closed by the ball 52 being pressed against the end opening of the drain passage 44.

Therefore, when the electromagnetic actuator 5 is not being energized, the end opening of the drain passage 44 is closed by the ball 52, whereby the control chamber 45 is filled with high-pressure fuel, so that by means of the valve piston 23, the nozzle hole 35 is closed by the nozzle needle 32, so fuel injection does not take place. When the electromagnetic actuator 5 is being energized, the ball 52 separates from the end opening of the drain passage 44, whereby high-pressure fuel in the control chamber 45 escapes to the fuel low-pressure section, so the pressure in the control chamber 45 decreases and fuel injection takes place. When the energizing of the electromagnetic actuator 5 is stopped, the nozzle needle 32 again closes the nozzle hole 35, terminating the fuel injection.

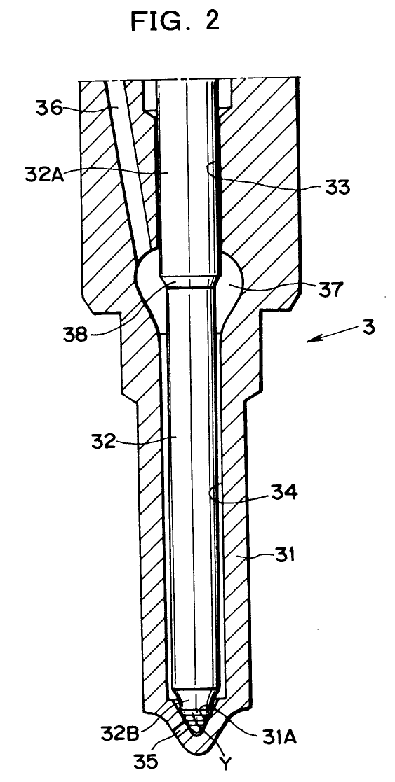

FIG. 2 is an enlarged detailed view of the nozzle 3 of FIG. 1. The nozzle needle 32 is guidably supported in the hole 33 of the nozzle body 31 by the large-diameter portion 32A thereof. The tip 32B of the nozzle needle 32 closes the nozzle hole 35 by seating on the seat 31A formed on the inside of the nozzle body 31 by the nozzle hole 35, thereby closing the fuel injection valve. On the other hand, the fuel injection valve is opened by lifting the nozzle needle 32, which separates the tip 32B from the seat 31A.

Therefore, over an extended period of time, the tip 32B repeatedly impacting against the seat 31A when the fuel injection valve 1 is closed gradually wears the seat 31A, changing the fuel injection characteristics of the fuel injection valve 1. To prevent such trouble occurring, in the fuel injection valve I according to the present invention, a coating layer Y is provided on the area of contact between the nozzle needle 32 and the seat 31A to reduce the frictional resistance with the nozzle body 31 (that is, with the seat 31A).

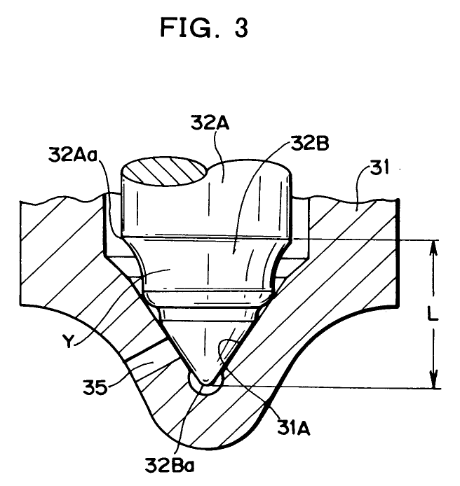

As shown in further detail in FIG. 3, the coating layer Y is provided within the surface range indicated in FIG. 3 by the symbol L; that is, from the projecting portion 32Ba at the tip 32B to the portion 32Aa at which the large-diameter portion 32A ends. Here, the coating layer Y is provided over the entire tip of the nozzle needle 32, including the area of contact with the seat 31A. However, the coating layer Y may be provided over the entire surface of the nozzle needle 32.

Preferably, the coating layer Y is a hard, amorphous carbon film such as a DLC (Diamond-Like Carbon) thin film fabricated by the ionization vapor deposition method. A DLC thin film has good surface smoothness with a coefficient of friction in the order of 0.1. In contrast, nickel chrome molybdenum steel (SNCM) is usually used for the nozzle body 31 and high-speed machine steel (SKH) for the nozzle needle 32, and these have a coefficient of friction in the order of 0.35 to 0.40. Therefore, providing the tip 32B of the nozzle needle 32 with the coating layer Y enables the frictional resistance between the tip 32B and the seat 31A to be reduced to one-third or less than in the prior art. As a result, wear of the seat 31A when the tip 32B of the nozzle needle 32 seats on the seat 31A of the nozzle body 31 can be reduced, making it possible to keep down changes over time in the fuel injection characteristics of the fuel injection valve 1.

It is desirable for the coating layer Y to be formed with a thickness of 0.1 μm to 30 μm. From the standpoint of adhesion and wear resistance, a thickness of from 1 μm to 5 μm is more preferable. The coefficient of friction between the coating layer Y and the nozzle body 31 is preferably not more than 0.2, and from the standpoint of wear resistance, is more preferably not more than 0.1. Preferably, the coating layer Y should have a Vickers hardness of not less than 2000.

When the coating layer Y is provided on the nozzle needle 32 as described in the above, when the fuel injection valve 1 closes, between the time from when the tip of the nozzle needle 32 contacts the seat 31A of the nozzle body 31 to when the tip of the nozzle needle 32 is pressed against the seat 31A of the nozzle body 31, the tip of the nozzle needle 32 slides on the seat 31A in a state of low frictional resistance. Therefore, wear on the seat 31A arising when the valve is closed can be reduced compared to when the coating layer Y is not provided. As a result, the fuel injection valve 1 can be operated over an extended period of time with the required fuel injection characteristics.

### EXAMPLE

Ionization vapor deposition was used to form the coating layer Y as a DLC thin film on the tip 32B, as shown in FIG. 3. The coating layer Y had a thickness of 4 μm, and coefficient of friction between the coating layer Y and the nozzle body 31 was 0.1. The amount of wear on the seat 31A and changes over time in the injection amount of the fuel injection valve 1 were measured.

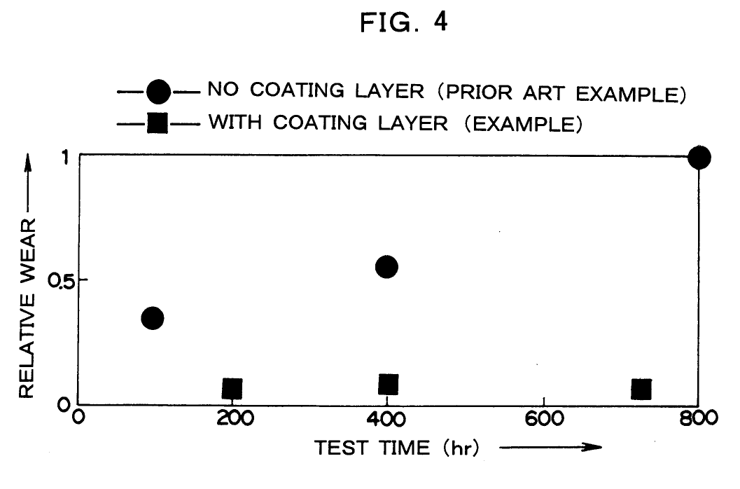

The results of the measurements are shown in FIG. 4. In FIG. 4, the horizontal axis is test time (hr) and the vertical axis is relative wear. The relative wear is the ratio used with respect to 1 taken as the maximum value of wear obtained after testing a conventional nozzle body. When compared to a fuel injection valve having a conventional configuration using a high-speed machine steel nozzle body and a nickel chrome molybdenum steel nozzle needle, with respect to nozzle body wear, the Example remained stable, with almost no increase in the amount of wear, and the amount of wear was one-half to one-sixth that of the conventional fuel injection valve.

### INDUSTRIAL APPLICABILITY

As described in the foregoing, the fuel injection valve according to this invention is useful for improving fuel injection valves, being able to keep down changes over time in the fuel injection characteristics of the fuel injection valve.

1. In a fuel injection valve having a nozzle body with a nozzle hole(s) at its tip that is opened and closed by a nozzle housed in the nozzle body,
a fuel injection valve characterized in that an area of contact between the nozzle needle and a seat on the nozzle body is provide with a coating laying to reduce the friction resistance with the nozzle body.

2. A fuel injection valve as claimed in claim 1, wherein the coating layer is provided over the entire surface of the nozzle needle.

3. A fuel injection valve as claimed in claim 1, wherein the coating layer is a C2 coating layer.

4. A fuel injection valve as claimed in claim 1, wherein the coating layer is a hard, amorphous carbon film fabricated by ionization vapor deposition.

5. A fuel injection valve as claimed in claim 1, wherein the coating layer is provided as a DCL thin film.

6. A fuel injection valve as claimed in claim 1, wherein the coating layer has a thickness of from 0.1 μm to 30 μm.

7. A fuel injection valve as claimed in claim 1, wherein the coating layer has a thickness of from 1 μm to 5 μm.

8. A fuel injection valve as claimed in claim 1, wherein a coefficient of friction between the coating layer and the nozzle body is not more than 0.2.

9. A fuel injection valve as claimed in claim 1, wherein a coefficient of friction between the coating layer and the nozzle body is not more than 0.1.

10. A fuel injection valve as claimed in claim 2, wherein the coating layer has a thickness of from 0.1 μm to 30 μm.

11. A fuel injection valve as claimed in claim 3, wherein the coating layer has a thickness of from 0.1 μm to 30 μm.

12. A fuel injection valve as claimed in claim 4, wherein the coating layer has a thickness of from 0.1 μm to 30 μm.

13. A fuel injection valve as claimed in claim 2, wherein the coating layer has a thickness of from 1 μm to 5 μm.

14. A fuel injection valve as claimed in claim 3, wherein the coating layer has a thickness of from 1 μm to 5 μm.

15. A fuel injection valve as claimed in claim 4, wherein the coating layer has a thickness of from 1 μm to 5 μm.

16. A fuel injection valve as claimed in claim 2, wherein a coefficient of friction between the coating layer and the nozzle body is not more than 0.2.
